(19) United States
(12) Patent Application Publication
(10) Pub. No.: US 2023/0406964 A1
(43) Pub. Date: Dec. 21, 2023

(54) DISPERSANT FOR SUSPENSION POLYMERIZATION AND METHOD FOR PRODUCING VINYL POLYMER

(71) Applicant: KURARAY CO., LTD., Kurashiki-shi (JP)

(72) Inventors: Misuzu FUJIMORI, Kurashiki-shi (JP); Masaki KATO, Houston, TX (US); Tatsuya TANIDA, Tainai-shi (JP)

(73) Assignee: KURARAY CO., LTD., Kurashiki-shi (JP)

(21) Appl. No.: 18/251,593

(22) PCT Filed: Oct. 29, 2021
(86) PCT No.: PCT/JP2021/039941

§ 371 Date: May 3, 2023

(30) Foreign Application Priority Data
Nov. 4, 2020 (JP) 2020-184322

(51) Int. Cl. C08F 2/20; C08F 16/06; C08F 14/06; C08F 2/38

(52) U.S. Cl. CPC C08F 2/20; C08F 16/06; C08F 14/06; C08F 2/38

(57) ABSTRACT

A dispersant for suspension polymerization may, even when a usage amount thereof is low, enable obtaining polymer particles having a small average particle diameter with few coarse particles, and having favorable plasticizer absorptivity. Such a dispersant may include a vinyl alcohol polymer having a structure of following formula (1)

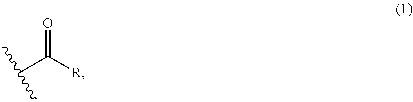

and satisfy inequality (2)

0.4≤[X]×10²/[R_{a,1}]²≤3.0 (2).

In formula (1), R is a hydrocarbon group having 4 or more carbon atoms. In inequality (2), [X] is a mole percentage content of the structure of formula (1) with respect to total structural units of the vinyl alcohol polymer; and [R_{a,1}] is an HSP distance ((J/cm³)^{1/2}) between the structure of formula (1) and vinyl chloride.

### TECHNICAL FIELD

The present invention relates to a dispersant for suspension polymerization and a method for producing a vinyl polymer.

### BACKGROUND ART

Vinyl alcohol polymers (hereinafter, may be also abbreviated to “PVAs”) are commonly used as dispersants for suspension polymerization of a vinyl compound. In the suspension polymerization, a particulate vinyl polymer is obtained by using an oil-soluble catalyst to polymerize a vinyl compound dispersed in an aqueous medium. At this time, a dispersant is added to the aqueous medium with the purpose of improving quality of the polymer to be obtained. Factors controlling the quality of the vinyl polymer to be obtained by subjecting the vinyl compound to suspension polymerization include a conversion (rate of polymerization), a ratio of water to the vinyl compound (monomer), a polymerization temperature, a type and amount of the oil-soluble catalyst, a form of polymerization vessel, a stirring speed of contents in the polymerization vessel, a type of the dispersant, and the like. Of these, the type of the dispersant greatly influences aspects of the quality such as plasticizer absorptivity and a particle size distribution of the vinyl polymer. The PVA may be used as the dispersant either alone of one type, or in a combination of different types of PVAs, or may be combined with a cellulose derivative such as methyl cellulose or carboxymethyl cellulose, or the like.

For example, Patent Document 1 discloses a dispersant constituted from a PVA having: an average degree of polymerization being 500 or more; a ratio (Pw/Pn) of a weight average degree of polymerization Pw to a number average degree of polymerization Pn being 3.0 or less: a structure [—CO—(CH═CH)₂-] containing a carbonyl group and a vinylene group adjacent thereto; absorbances in a 0.1% aqueous solution at wavelengths of 280 nm and 320 nm being 0.3 or more and 0.15 or more, respectively; and a ratio (b)/(a) of the absorbance (b) at the wavelength of 320 nm to the absorbance (a) at the wavelength of 280 nm being 0.30 or more.

### PRIOR ART DOCUMENTS

### Patent Documents

Patent Document 1: Japanese Unexamined Patent Application, Publication No. H5-88251

### SUMMARY OF THE INVENTION

### Problems to be Solved by the Invention

It is an object of the present invention to provide: a dispersant for suspension polymerization which, even when a usage amount thereof is low, enables obtaining polymer particles having a small average particle diameter with few coarse particles, and having favorable plasticizer absorptivity; and a method for producing a vinyl polymer.

### Means for Solving the Problems

The aforementioned problems can be solved by providing any of the following:

(1) A dispersant for suspension polymerization, the dispersant containing a vinyl alcohol polymer having a structure which is represented by the following formula (1) and satisfies the following inequality (2):

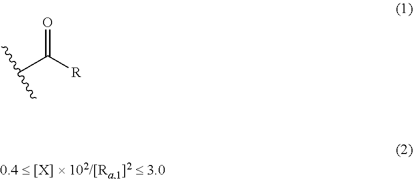

wherein, in the formula (1), R represents a hydrocarbon group having 4 or more carbon atoms, and
in the inequality (2):
   [X] represents a percentage content (mol %) of the structure represented by the formula (1) with respect to total structural units of the vinyl alcohol polymer; and
   [R_{a,1}] represents an HSP distance ((J/cm³)^{1/2}) between the structure represented by the formula (1) and vinyl chloride;

(2) The dispersant for suspension polymerization according to (1), wherein a degree of saponification of the vinyl alcohol polymer is 60 mol % or more and 99.5 mol % or less;

(3) The dispersant for suspension polymerization according to (1) or (2), wherein a viscosity-average degree of polymerization of the vinyl alcohol polymer is 150 or more and 5,000 or less;

(4) The dispersant for suspension polymerization according to any one of (1) to (3), wherein the vinyl alcohol polymer satisfies the following inequality (3):

3.5≤[X]×10⁵/[R_{a,2}]^{2≤}25 (3)
wherein, in the inequality (3):
   the definition of [X] is the same as that in the inequality (2); and
   [R_{a,2}] represents an HSP distance ((J/cm³)^{1/2}) between the structure represented by the formula (1) and water; and

(5) A method for producing a vinyl polymer, the method including a step of subjecting a vinyl compound to suspension polymerization in the presence of the dispersant for suspension polymerization according to any one of (1) to (4).

### Effects of the Invention

The present invention enables providing: a dispersant for suspension polymerization which, even when a usage amount thereof is low, enables obtaining polymer particles having a small average particle diameter with few coarse particles, and having favorable plasticizer absorptivity; and a method for producing a vinyl polymer.

### DESCRIPTION OF EMBODIMENTS

Hereinafter, embodiments for carrying out the present invention are described. It is to be noted that in the present specification, upper limit values and lower limit values of ranges of numerical values (contents of respective components, values and physical properties calculated from respective components, etc.) can be combined as appropriate.

### Dispersant for Suspension Polymerization

The dispersant for suspension polymerization (hereinafter, may be also referred to as the “dispersant”) contains a vinyl alcohol polymer (PVA).

PVA

The PVA is a polymer having a vinyl alcohol unit as a structural unit. The PVA has a structure represented by the following formula (1). The structure represented by the formula (1) is typically located at an end of the PVA.

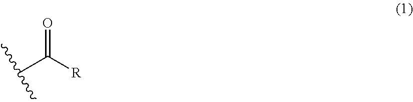

In the formula (1), R represents a hydrocarbon group having 4 or more carbon atoms. When the number of carbon atoms in R is less than 4, in a case of the usage amount of the dispersant being low, obtaining the polymer particles having a small average particle diameter with few coarse particles may fail. Furthermore, the PVA can be obtained by: polymerizing vinyl acetate using an aldehyde having 5 or more carbon atoms as a chain transfer agent; and then performing saponification, but in a case of using an aldehyde having 3 or 4 carbon atoms, separation of unreacted aldehyde and vinyl acetate is difficult, whereby it may be difficult to reuse the vinyl acetate. In other words, the PVA in which R in the formula (1) has 4 or more carbon atoms is superior in production efficiency. The lower limit of the number of carbon atoms in R is preferably 5, and may be more preferably 6. On the other hand, the upper limit of the number of carbon atoms in R is preferably 12, more preferably 10, and may be still more preferably 8. When the upper limit of the number of carbon atoms in R is the above-described value, obtaining the polymer particles having a small average particle diameter with few coarse particles is facilitated, and production can be performed inexpensively due to superior availability of materials.

The hydrocarbon group represented by R may be an aromatic hydrocarbon group such as a phenyl group, or an aliphatic hydrocarbon group, and is preferably an aliphatic hydrocarbon group. The aliphatic hydrocarbon group may be exemplified by: a chain aliphatic hydrocarbon group such as an alkyl group, an alkenyl group, and an alkynyl group; and a cyclic aliphatic hydrocarbon group such as a cycloalkyl group, a cycloalkenyl group, and a cycloalkynyl group, and the chain aliphatic hydrocarbon group is preferred. The chain aliphatic hydrocarbon group may be a linear group, or may be a group having a branch. Furthermore, the aliphatic hydrocarbon group may be a saturated aliphatic hydrocarbon group such as an alkyl group or an unsaturated aliphatic hydrocarbon group such as an alkenyl group, and is preferably the saturated aliphatic hydrocarbon group. The hydrocarbon group represented by R is more preferably an alkyl group, and still more preferably a linear alkyl group. Examples of the alkyl group represented by R include a butyl group, a pentyl group, a hexyl group, a heptyl group, an octyl group, a nonyl group, a decyl group, and the like.

The PVA satisfies the following inequality (2).

0.4≤[X]×10²/[R_{a,1}]²≤3.0 (2)

In the inequality (2):
[X] represents a percentage content (mol %) of the structure represented by the formula (1) with respect to total structural units of the vinyl alcohol polymer; and
[R_{a,1}] represents an HSP distance ((J/cm³)^{1/2}) between the structure represented by the formula (1) and vinyl chloride.

Due to containing the PVA which satisfies the inequality (2), the dispersant of the present invention enables stabilizing polymerization of a vinyl compound, even when a usage amount of the dispersant is low; thus, the dispersant achieves a superior effect of reducing blocking, which occurs due to the polymerization being unstable. As a result, polymer particles having a small average particle diameter with few coarse particles, and being superior in plasticizer absorptivity can be obtained.

Although the reasons for the dispersant of the present invention achieving such effects are not clarified, it is speculated as follows. The HSP distance represented by [R_{a,1}] being small means that miscibility is high between the structure represented by the formula (1) and the vinyl compound such as vinyl chloride. Furthermore, a content of the structure represented by the formula (1) affects miscibility between the PVA and the vinyl compound. Consequently, it is considered that ([X]×10²/[R_{a,1}]²) can show the degree of miscibility between the PVA and the vinyl compound. When ([X]×10²/[R_{a,1}]²) is less than 0.4, in suspension polymerization, an amount of the PVA present at an interface between the vinyl compound, being a monomer, and water decreases, whereby obtaining the polymer particles having a small average particle diameter with few coarse particles may fail. On the other hand, it is difficult to produce the PVA in which ([X]×10²/[R_{a,1}]²) is more than 3.0. Furthermore, since the PVA in which ([X]×10²/[R_{a,1}]²) is more than 3.0 has low water solubility, handling when performing suspension polymerization may be poor. The lower limit of ([X]×10²/[R_{a,1}]²) is preferably 0.5, more preferably 0.6, still more preferably 0.7, and may be preferably 0.8, 0.9, or 0.95. On the other hand, the upper limit of ([X]×10²/[R_{a,1}]²) is preferably 2.9, more preferably 2.8, still more preferably 2.7, and may be preferably 2.6 or 2.5.

The lower limit of a percentage content [X] of the structure represented by the formula (1) with respect to total structural units of the PVA is preferably 0.01 mol %, more preferably 0.03 mol %, still more preferably 0.05 mol %, and may be yet more preferably 0.07 mol %, 0.08 mol %, 0.09 mol %, or 0.10 mol %. When [X] is more than or equal to the lower limit, even when the usage amount of the dispersant is low, the polymer particles having a small average particle diameter with few coarse particles are more easily obtained. On the other hand, the upper limit of [X] is preferably 3 mol %, more preferably 2 mol %, and may be still more preferably 1.5 mol %, 1.2 mol %, 1.0 mol %, 0.8 mol %, 0.6 mol %, 0.5 mol %, or 0.4 mol %. When [X] is less than or equal to the upper limit, the polymer particles obtained by the suspension polymerization tend to be superior in plasticizer absorptivity.

[X] can be calculated by a ¹H-NMR analysis of the PVA, having been re-saponified until the degree of saponification becomes 99.5 mol %. More specifically, [X] can be calculated by a method described in EXAMPLES.

The lower limit of the HSP distance [R_{a,1}] between the structure represented by the formula (1) and vinyl chloride is preferably 1 (J/cm³)^{1/2}, more preferably 2 (J/cm³)^{1/2}, and may be still more preferably 2.5 (J/cm³)^{1/2} or 2.8 (J/cm³)^{1/2}. On the other hand, the upper limit of the HSP distance [R_{a,1}] between the structure represented by the formula (1) and vinyl chloride is preferably 5.5 (J/cm³)^{1/2}, more preferably 4.9 (J/cm³)^{1/2}, and may be preferably 4.5 (J/cm³)^{1/2}, 4.2 (J/cm³)^{1/2}, 4.0 (J/cm³)^{1/2}, or 3.8 (J/cm³)^{1/2}. When [R_{a,1}] falls within the above range, even in a case in which the usage amount of the dispersant is low, the polymer particles having a small average particle diameter with few coarse particles are more easily obtained, and the polymer particles tend to be superior in plasticizer absorptivity as well.

The HSP distance [R_{a,1}] between the structure represented by the formula (1) and vinyl chloride can be calculated by a method described in “SP Values: Fundamentals, Application, and Calculation Method”, written by Hideki Yamamoto (published in 2005, Johokiko Co., Ltd.), and “Polymer Handbook (Fourth Edition)”, written by J. Brandrup (published in 2003, Wiley). Furthermore, identification of the structure represented by the formula (1) in the PVA can be calculated by a ¹H-NMR analysis of the PVA, having been re-saponified until the degree of saponification becomes 99.5 mol %. Specifically, the calculation can be carried out in accordance with the method described in EXAMPLES.

Hereinafter, the method for calculating the HSP distance [R_{a,1}] is described in detail. The HSP distance between two substances is a parameter which corresponds to a distance between two points when considering HSP values (δd, δp, δh) as coordinates in a three-dimensional space. HSP values are expressed by the three components of a dispersion term (δd), a polar term (δp), and a hydrogen-bonding term (δh). For example, in a case in which the structure represented by the formula (1) is a structure represented by the following formula (4), after using the following equation (5) to determine a molar volume (V) of the structure represented by the following formula (4), δd, δp, and δh of this structure can be determined by the following equations (6) to (8). It is to be noted that m in the following equation (5) is a numerical value of 3 or more, and in light of a measurement error in the ¹H-NMR analysis, a case in which a plurality of types of structures represented by the formula (1) are incorporated in the PVA, and the like, it is not necessary form to be an integer. Also in a case in which the structure represented by the following formula (1) is a structure other than the structure represented by the following formula (4), in accordance with the following method, the calculation can be carried out by the method described in “SP Values: Fundamentals, Application, and Calculation Method”, written by Hideki Yamamoto (published in 2005, Johokiko Co., Ltd.), and “Polymer Handbook (Fourth Edition)”, written by J. Brandrup (published in 2003, Wiley).

—(C═O)—(CH₂)ₘ—CH₃ (4)

V=33.5+16.1 m+10.8 (5)

δd=(420+270 m+290)/V (6)

δp=770/V (7)

δh=(2,000/V)^{1/2} (8)

Furthermore, the HSP values adopted for vinyl chloride are (δD₁, δP₁, δH₁)=(15.4, 8.1, 2.4).

The HSP distance [R_{a,1}] can be determined in accordance with the following equation (9) by using these values.

[R_{a,1}]={4(δD₁−δd)²+(δP₁−δp)²+(δH₁−δh)²}^{1/2} (9)

The PVA preferably satisfies the following inequality (3).

3.5≤[X]×10⁵/[R_{a,2}]²≤25 (3)

In the inequality (3), [X] represents the percentage content (mol %) of the structure represented by the formula (1) with respect to the total structural units of the PVA; and [R_{a,2}] represents an HSP distance ((J/cm³)^{1/2}) between the structure represented by the formula (1) and water. The lower limit of ([X]×10⁵/[R_{a,2}]2) is preferably 4, more preferably 6, and may be still more preferably 7, 8, 9, or 10. On the other hand, the upper limit of [X]×10⁵/[R_{a,2}]2 is preferably 22, more preferably 20, and may be still more preferably 18, 16, or 15. It is considered that ([X]×10⁵/[R_{a,2}]2) can show the degree of miscibility between the PVA and water. When ([X]×10⁵/[R_{a,2}]²) falls within the above range, even in a case in which the usage amount of the dispersant is low, the polymer particles having a small average particle diameter with few coarse particles are more easily obtained, and the polymer particles tend to be superior in plasticizer absorptivity as well.

The upper limit of the HSP distance [R_{a,2}] between the structure represented by the formula (1) and water is preferably 45 (J/cm³)^{1/2}, and may be more preferably 42 (J/cm³)^{1/2} On the other hand, the lower limit of the HSP distance [R_{a,2}] between the structure represented by the formula (1) and water is preferably 36 (J/cm³)^{1/2}. When [R_{a,2}] falls within the above range, even in a case in which the usage amount of the dispersant is low, the polymer particles having a small average particle diameter with few coarse particles are more easily obtained, and the polymer particles tend to be superior in plasticizer absorptivity as well.

The HSP distance [R_{a,2}] between the structure represented by the formula (1) and water can be calculated by the method described in “SP Values: Fundamentals, Application, and Calculation Method”, written by Hideki Yamamoto (published in 2005, Johokiko Co., Ltd.), and “Polymer Handbook (Fourth Edition)”, written by J. Brandrup (published in 2003, Wiley). Specifically, the calculation can be carried out in accordance with the same method as that of the HSP distance [R_{a,1}], described above. In other words, the HSP distance [R_{a,2}] can be determined in accordance with the following equation (10) from the HSP values (δd, δp, δh) of the structure represented by the formula (1), and the HSP values (δD₂, δP₂, δH₂) of water. It is to be noted that the HSP values adopted for water are (δD₂, δP₂, δH₂)=(15.5, 16.0, 42.4).

[R_{a,2}]={4(δD₂−δd)²+(δP₂−δp)²+(δH₂−δh)²}^{1/2} (10)

Typically, as described in detail later, the PVA is obtained by: polymerizing a vinyl ester in the presence of an aldehyde having 5 or more carbon atoms; and saponifying a vinyl ester polymer obtained. The lower limit of the degree of saponification of the PVA is preferably 20 mol %, more preferably 30 mol %, and may be still more preferably 40 mol %. On the other hand, the upper limit of the degree of saponification may be 100 mol %, and is preferably 99.5 mol %, more preferably 99.2 mol %, still more preferably 99 mol %, and may be preferably 95 mol % or 90 mol %. In a case of using the dispersant of the present invention as a primary dispersant, the lower limit of the degree of saponification of the PVA is preferably 60 mol %, more preferably 65 mol %, and still more preferably 68 mol %. In a case of using the dispersant of the present invention as a secondary dispersant, the upper limit of the degree of saponification of the PVA is preferably 80 mol %, more preferably 70 mol %, and may be still more preferably 60 mol %. When the degree of saponification of the PVA falls within the above range, the effects of the present invention can be further improved due to, e.g., surface active performance being optimized. It is to be noted that the primary dispersant as referred to means an additive used in order to, e.g., enhance monomer dispersability at a time of suspension polymerization and control a particle size of the polymer particles to be obtained. On the other hand, the secondary dispersant as referred to means typically an additive used together with the primary dispersant in order to, e.g., increase particularly a porosity of the polymer particles to be obtained. The degree of saponification is a value measured in accordance with a method described in JIS K6726: 1994.

The lower limit of a viscosity-average degree of polymerization of the PVA is preferably 100, more preferably 120, still more preferably 150, yet more preferably 160, and may be even more preferably 200, 300, 400, 500, or 600. When the viscosity-average degree of polymerization is more than or equal to the lower limit, a protective colloid property can increase, and various types of performance as a dispersant, such as polymerization stability, can further improve. On the other hand, the upper limit of this viscosity-average degree of polymerization is preferably 5,000, more preferably 3,500, still more preferably 2,000, and may be yet more preferably 1,500, 1,000, or 800. When the viscosity-average degree of polymerization is less than or equal to the upper limit, the surface active performance can improve, and various types of performance as a dispersant can further improve. In the case of using the dispersant of the present invention as the primary dispersant, the lower limit of the viscosity-average degree of polymerization of the PVA is preferably 200, more preferably 300, still more preferably 400, yet more preferably 500, and particularly preferably 600. In the case of using the dispersant of the present invention as the secondary dispersant, the upper limit of the viscosity-average degree of polymerization of the PVA is preferably 800, more preferably 700, and still more preferably 600. The viscosity-average degree of polymerization of the PVA is a value measured in accordance with a method described in JIS K6726: 1994. Specifically, the viscosity-average degree of polymerization can be determined by the following equation (11), using a limiting viscosity [η] (L/g) measured in water at 30° C. on the PVA, having been re-saponified until the degree of saponification becomes 99.5 mol % or more and then generated:

viscosity-average degree of polymerization=([η]×10⁴/8.29)^{(1/0.62)} (11)

The PVA preferably has a structure represented by the following formula (12).

—CO—(CH═CH)ₚ— (12)

In the formula (12), p is an integer of 1 to 5.

The structure represented by the formula (12) is, for example, formed by heat-treating the PVA having the structure represented by the formula (1). The carbonyl group in the structure represented by the formula (12) and the carbonyl group in the structure represented by the formula (1) may be the same. In other words, the terminal structure of the PVA may be a structure represented by R—CO—(CH═CH)ₚ—. In the case in which the PVA has the structure represented by the formula (12), absorption occurs at a wavelength of 320 nm. Thus, the lower limit of an absorbance of a 0.1% by mass aqueous solution of the PVA at an optical path length of 10 mm and a wavelength of 320 nm is preferably 0.05, more preferably 0.1, and may be still more preferably 0.15, 0.20, or 0.25. When the absorbance is more than or equal to the lower limit, the structure represented by the formula (12) can be sufficiently formed in the PVA, whereby the polymer particles having a smaller average particle diameter with fewer coarse particles can be obtained. Thus, in particular even when the usage amount of the dispersant is low, it is possible to obtain the polymer particles having a small average particle diameter with few coarse particles, and having favorable plasticizer absorptivity.

On the other hand, the upper limit of the absorbance of the 0.1% by mass aqueous solution of the PVA at the optical path length of 10 mm and the wavelength of 320 nm is preferably 0.4, more preferably 0.35, and may be still more preferably 0.30 or 0.25. When the structure represented by the formula (12) is excessively formed in the PVA, there may be an effect on the plasticizer absorptivity of the polymer particles to be obtained. Thus, in the case in which the absorbance is less than or equal to the upper limit, the plasticizer absorptivity of the polymer particles to be obtained can be enhanced.

In a case in which the PVA has a formyl group (—COH) at an end thereof, a percentage content of the formyl group with respect to the total structural units of the PVA is preferably 3.5 mmol % or less, more preferably 3.0 mmol % or less, and may be still more preferably 2.5 mmol % or less. The lower limit of the percentage content is not particularly limited, and the PVA may not substantially have a formyl group at the end thereof. In the present invention, various types of performance as a dispersant may be improved due to the formyl group being scarcely present at the end of the PVA, and in particular, the plasticizer absorptivity of the polymer particles to be obtained may be enhanced. It is to be noted that the percentage content of the formyl group at the end of the PVA tends to increase in, e.g., a case of conducting polymerization in a system into which oxygen is supplied. Furthermore, the degree of polymerization of the PVA also affects the percentage content of the formyl group at the end. The percentage content of the formyl group can be calculated by conducting a ¹H-NMR measurement after washing the PVA with methanol or the like to eliminate unreacted aldehyde and the like.

The PVA may have an other structural unit aside from the structure represented by the formula (1) and structural units derived from vinyl esters (a vinyl alcohol unit and a vinyl ester unit). Examples of a monomer that gives the other structural unit include: α-olefins such as ethylene, propylene, n-butene, and isobutylene; acrylic acid and salts thereof; acrylic acid esters such as methyl acrylate, ethyl acrylate, n-propyl acrylate, i-propyl acrylate, n-butyl acrylate, i-butyl acrylate, t-butyl acrylate, 2-ethylhexyl acrylate, dodecyl acrylate, and octadecyl acrylate; methacrylic acid and salts thereof; methacrylic acid esters such as methyl methacrylate, ethyl methacrylate, n-propyl methacrylate, i-propyl methacrylate, n-butyl methacrylate, i-butyl methacrylate, t-butyl methacrylate, 2-ethylhexyl methacrylate, dodecyl methacrylate, and octadecyl methacrylate; acrylamide; acrylamide derivatives such as N-methylacrylamide, N-ethylacrylamide, N,N-dimethylacrylamide, diacetone acrylamide, acrylamidepropane sulfonic acid and salts thereof, acrylamide propyl dimethylamine and salts thereof or quaternary salts thereof, and N-methylolacrylamide and derivatives thereof; methacrylamide; methacrylamide derivatives such as N-methylmethacrylamide, N-ethylmethacrylamide, methacrylamidepropane sulfonic acid and salts thereof, methacrylamidepropyldimethylamine and salts thereof or quaternary salts thereof, and N-methylolmethacrylamide and derivatives of the same; vinyl ethers such as methyl vinyl ether, ethyl vinyl ether, n-propyl vinyl ether, i-propyl vinyl ether, n-butyl vinyl ether, i-butyl vinyl ether, t-butyl vinyl ether, dodecyl vinyl ether, and stearyl vinyl ether; nitriles such as acrylonitrile and methacrylonitrile; vinyl halides such as vinyl chloride and vinyl fluoride; vinylidene halides such as vinylidene chloride and vinylidene fluoride; allyl compounds such as allyl acetate and allyl chloride; unsaturated dicarboxylic acids such as maleic acid, itaconic acid, and fumaric acid and salts thereof, or mono- or dialkyl esters thereof; vinylsilyl compounds such as vinyltrimethoxysilane; isopropenyl acetate and 3,4-diacetoxy-1-butene; and the like. Either one, or two or more types of the other monomer may be used.

A proportion of the other structural unit with respect to the total structural units in the PVA may be preferably 20 mol % or less, may be more preferably 10 mol % or less, and may be still more preferably 5 mol %, 3 mol %, or 1 mol %. On the other hand, the proportion of the other structural unit may be, for example, 0.1 mol % or more, or may be 1 mol % or more.

Procedure for Producing PVA

A procedure for producing the PVA contained in the dispersant of the present invention is not particularly limited, and for example, a procedure can be exemplified in which a vinyl ester monomer is polymerized after adding an aldehyde having 5 or more carbon atoms as a modification agent, and a vinyl ester polymer thus obtained is saponified.

The aldehyde is preferably an alkyl aldehyde, and examples thereof include: linear alkyl aldehydes such as 1-pentanal, 1-hexanal, 1-heptanal, 1-octanal, 1-nonanal, 1-decanal, and 1-undecanal; linear alkenyl aldehydes such as 7-octenal; and branched alkyl aldehydes such as 2-methylbutanal, 2-ethylhexanal, 2-ethylbutanal, and 2-methylundecanal. The aldehyde may be used either alone of one type, or in a combination of two or more types. When the vinyl ester monomer is polymerized in the presence of the aldehyde, the aldehyde acts as a chain transfer agent, whereby the PVA having the structure represented by the formula (1) can be easily produced. A usage amount of the aldehyde is not particularly limited, and for example, with respect to 100 parts by mass of the vinyl ester monomer, is preferably 0.5 parts by mass or more and 20 parts by mass or less.

The aldehyde typically acts as a chain transfer agent. In polymerizing the vinyl ester monomer, an other chain transfer agent aside from the aldehyde may be used together with the aldehyde. Examples of the other chain transfer agent include: aldehydes (for example, acetaldehyde, 1-propanal, and 1-butanal) other than the aldehyde described above; ketones such as acetone, methyl ethyl ketone, hexanone, and cyclohexanone; mercaptans such as 2-hydroxyethanethiol; thiocarboxylic acids such as 3-mercaptopropionate and thioacetic acid; halogenated hydrocarbons such as trichloroethylene and perchloroethylene; and the like. An amount of addition of the chain transfer agent may be decided in accordance with a chain transfer constant of this chain transfer agent, a degree of polymerization of the PVA to be achieved, and/or the like.

A procedure for polymerizing the vinyl ester monomer is exemplified by bulk polymerization, solution polymerization, suspension polymerization, emulsion polymerization, dispersion polymerization, and the like, and from an industrial perspective, solution polymerization, emulsion polymerization, or dispersion polymerization is preferred. The polymerization of the vinyl ester polymer may involve a polymerization system selected from a batch system, a semi-batch system, and a continuous system.

Examples of the vinyl ester monomer include vinyl acetate, vinyl formate, vinyl propionate, vinyl caprylate, vinyl versatate, and the like, and of these, from an industrial perspective, vinyl acetate is preferred. The PVA may be a homopolymer of one type of the vinyl ester monomer, or may be a copolymer of different vinyl ester monomers.

A polymerization initiator used in the polymerization may be selected from well-known polymerization initiators such as, e.g., an azo type initiator, a peroxide type initiator, and a redox type initiator, depending on the polymerization procedure. Examples of the azo type initiator include 2,2′-azobisisobutyronitrile, 2,2′-azobis(2,4-dimethylvaleronitrile), 2,2′-azobis(4-methoxy-2,4-dimethylvaleronitrile), and the like. Examples of the peroxide type initiator include: peroxydicarbonate compounds such as diisopropyl peroxydicarbonate, di(2-ethylhexyl)peroxydicarbonate, and diethoxyethyl peroxydicarbonate; perester compounds such as t-butyl peroxyneodecanate and α-cumyl peroxyneodecanate; acetylcyclohexylsulfonyl peroxide; 2,4,4-trimethylpentyl-2-peroxyphenoxyacetate; and the like. As the polymerization initiator, potassium persufate, ammonium persulfate, hydrogen peroxide, or the like may be used in combination with the initiator described above. The redox type initiator is a polymerization initiator prepared by combining, for example, the peroxide type initiator or an oxidizing agent (potassium persulfate, ammonium persulfate, hydrogen peroxide, or the like) with a reducing agent such as sodium bisulfite, sodium bicarbonate, tartaric acid, L-ascorbic acid, or Rongalit. Although the amount of the polymerization initiator used cannot be generally predetermined since the amount may vary depending on the polymerization catalyst, the amount may be selected in accordance with a polymerization rate.

The PVA may, within a range not impairing the principles of the present invention, be produced by saponifying a vinyl ester copolymer prepared by copolymerizing the vinyl ester monomer with an other unsaturated monomer which is copolymerizable. The other monomer is exemplified by monomers which give the other structural unit, described above.

With the purpose of improving the water solubility, the PVA may be produced by saponification of a copolymer prepared by copolymerizing the vinyl ester monomer with an unsaturated monomer such as an unsaturated carboxylic acid, an unsaturated dicarboxylic acid, a salt thereof, a mono or dialkyl ester thereof, or the like. The PVA produced using alkylthiol as the chain transfer agent has low water solubility, whereby it often becomes necessary to take a measure such as copolymerizing with the unsaturated carboxylic acid, or using an organic solvent such as methanol when adjusting the aqueous solution. On the other hand, the PVA having the structure represented by the formula (1) and satisfying the inequality (2) has comparatively high water solubility even in a case of having a hydrocarbon chain with the same number of carbon atoms as alkylthiol. Thus, taking the above-described measure(s) is not necessarily needed, and the present invention is superior in this regard as well.

For the saponification reaction of the vinyl ester polymer, an alcoholysis reaction or a hydrolysis reaction may be applied, each involving using a well-known basic catalyst such as sodium hydroxide, potassium hydroxide, or sodium methoxide, or a well-known acidic catalyst such as p-toluenesulfonate.

Examples of the solvent which may be used in the saponification reaction include alcohols such as methanol and ethanol; esters such as methyl acetate and ethyl acetate; ketones such as acetone and methyl ethyl ketone; aromatic hydrocarbons such as benzene and toluene; and the like. These may be used alone, or in a combination of two or more types thereof. Of these, using methanol or a methanol/methyl acetate mixed solution as the solvent, and conducting the saponification reaction in the presence of sodium hydroxide, acting as the basic catalyst, is preferred due to convenience.

Furthermore, as steps after the saponification step, the procedure for producing the PVA may include: a step of washing a resin solid containing the PVA; a step of drying the resin solid containing the PVA; a step of subjecting the resin solid containing the PVA to a heat treatment; and/or the like. A treatment temperature in the case of conducting the heat treatment can be, for example, 100° C. or more and 150° C. or less. Furthermore, a treatment time period can be, for example, 10 min or more and 3 hrs or less.

Other Components, Intended Usage, Etc.

The dispersant of the present invention contains the PVA, and may further contain other component(s). The lower limit of a content of the PVA in nonvolatile components in the dispersant of the present invention is preferably 30% by mass, more preferably 50% by mass, and may be still more preferably 70% by mass, 90% by mass, or 99% by mass. The upper limit of the content of the PVA in the nonvolatile components in the dispersant of the present invention may be 100% by mass. The nonvolatile components other than the PVA which may be contained in the dispersant of the present invention are exemplified by: PVAs other than the PVA of the present invention; resins other than the PVA(s); additives such as surfactants and plasticizers; compounds used during production; and the like. The lower limit of a content of total PVAs in the nonvolatile components in the dispersant of the present invention is preferably 50% by mass, more preferably 70% by mass, and may be still more preferably 80% by mass, 90% by mass, or 99% by mass. The upper limit of the content of the total PVAs in the nonvolatile components in the dispersant of the present invention may be 100% by mass. Furthermore, a content of volatile components in the dispersant of the present invention is typically 20% by mass or less, preferably 15% by mass or less, and more preferably 10% by mass or less. The volatile components which may be contained in the dispersant of the present invention are exemplified by alcohols, water, and the like. In other words, the dispersant of the present invention may be constituted from substantially only the PVA of the present invention. A form of the dispersant of the present invention is not particularly limited, and is typically a powder.

The dispersant of the present invention may be either of the primary dispersant (may be also referred to as the main dispersant or the dispersion stabilizer), or the secondary dispersant (may be also referred to as the dispersion aid). By using the secondary dispersant together with the primary dispersant, the dispersability can be further improved.

The dispersant of the present invention is suitable as a dispersant for suspension polymerization of a vinyl compound. Due to using the dispersant of the present invention, polymerization stability can improve, thereby enabling efficiently obtaining polymer particles having a small average particle diameter with few coarse particles. Furthermore, the polymer particles to be obtained by suspension polymerization using the dispersant of the present invention also tend to be favorable in plasticizer absorptivity. In particular, even when the usage amount is low, being, for example, 1,500 ppm or 1,000 ppm or less with respect to the monomer, the dispersant of the present invention enables obtaining polymer particles having a small average particle diameter with few coarse particles, and having favorable plasticizer absorptivity.

As needed, the dispersant of the present invention may contain additive(s) typically used in suspension polymerization, such as an antiseptic agent, a mildew-proofing agent, an antiblocking agent, a defoaming agent, and the like. A content of such additive(s) is typically 1.0% by mass or less. The additive(s) may be used either alone of one type, or in a combination or two or more types.

### Method for Producing Vinyl Polymer

The method for producing a vinyl polymer of the present invention includes a step of subjecting a vinyl compound to suspension polymerization in the presence of the dispersant of the present invention. Examples of the vinyl monomer include: halogenated vinyls such as vinyl chloride; vinyl ester monomers such as vinyl acetate and vinyl propionate; (meth)acrylic acid and esters and salts thereof; maleic acid, fumaric acid, and esters and anhydrides thereof; styrene, acrylonitrile, vinylidene chloride, and vinyl ether; and the like. Of these, subjecting vinyl chloride to suspension polymerization alone, or together with a monomer that can be copolymerized with vinyl chloride is suitable. Examples of the monomer that can be copolymerized with vinyl chloride include: vinyl ester monomers such as vinyl acetate and vinyl propionate; (meth)acrylic acid esters such as methyl (meth)acrylate and ethyl (meth)acrylate; α-olefins such as ethylene and propylene; unsaturated dicarboxylic acids such as maleic anhydride and itaconic acid; acrylonitrile, styrene, vinylidene chloride, and vinyl ether; and the like.

A medium to be used in the suspension polymerization is preferably an aqueous medium. Examples of the aqueous medium include water and a mixture containing water and an organic solvent. A content of water in the aqueous medium is preferably 90% by mass or more.

A mass ratio (aqueous medium/vinyl compound) of the aqueous medium to the vinyl compound when carrying out the suspension polymerization is typically 0.1 to 10, preferably 0.5 to 5, and still more preferably 0.9 to 2.

A usage amount of the dispersant of the present invention in the suspension polymerization is not particularly limited, and on a mass basis with respect to the vinyl compound is preferably 100 ppm or more and 50,000 ppm or less, more preferably 200 ppm or more and 20,000 ppm or less, and may be still more preferably 10,000 ppm or less, 5,000 ppm or less, 2,000 ppm or less, or 1,500 ppm or less.

The dispersant of the present invention may be used alone, or may be used together with: a water-soluble cellulose ether such as methyl cellulose, hydroxyethyl cellulose, hydroxypropyl cellulose, or hydroxypropyl methyl cellulose; a water-soluble polymer such as polyvinyl alcohol or gelatin; an oil-soluble emulsifier such as sorbitan monolaurate, sorbitan trioleate, glycerin tristearate, or an ethylene oxide-propylene oxide block copolymer; a water-soluble emulsifier such as polyoxyethylene sorbitan monolaurate, polyoxyethylene glycerin oleate, and sodium laurate; or the like. These may be used either alone of one type, or in a combination of two or more types.

In the suspension polymerization of the vinyl compound, an oil-soluble or water-soluble polymerization initiator conventionally used in polymerization of a vinyl chloride monomer or the like may be used. Examples of the oil-soluble polymerization initiator include: peroxydicarbonate compounds such as diisopropyl peroxydicarbonate, di(2-ethylhexyl) peroxydicarbonate, and diethoxyethyl peroxydicarbonate; perester compounds such as t-butyl peroxyneodecanate, t-butyl peroxypivalate, t-hexyl peroxypivalate, and α-cumyl peroxyneodecanate; peroxides such as acetylcyclohexylsulfonyl peroxide, 2,4,4-trimethylpentyl-2-peroxyphenoxyacetate, 3,5,5-trimethylhexanoyl peroxide, and lauroyl peroxide; azo compounds such as azobis-2,4-dimethylvaleronitrile and azobis(4-2,4-dimethylvaleronitrile); and the like. Examples of the water-soluble polymerization initiator include potassium persufate, ammonium persulfate, hydrogen peroxide, cumene hydroperoxide, and the like. These oil-soluble or water-soluble polymerization initiators may be used either alone of one type, or in a combination of two or more types.

In the suspension polymerization of the vinyl compound, various other additives may be added to the polymerization reaction system as needed. Examples of the additives include: polymerization modifiers such as aldehydes, halogenated hydrocarbons, and mercaptans; polymerization inhibitors such as phenol compounds, sulfur compounds, and N-oxide compounds; and the like. Furthermore, a pH adjuster, a cross-linking agent, and/or the like may also be optionally added.

In the suspension polymerization of the vinyl compound, a polymerization temperature is not particularly limited, and may be a low temperature of about 20° C. or a high temperature of more than 90° C. In addition, in one preferred embodiment, a polymerization vessel equipped with a reflux condenser may be also used in order to enhance heat removal efficiency of the polymerization reaction system.

In the method for producing a vinyl polymer of the present invention, a mass ratio (primary dispersant/secondary dispersant) of amounts of addition of the primary dispersant (for example, the dispersant of the present invention) and the secondary dispersant (for example, the dispersant of the present invention) varies in accordance with the type of dispersant to be used and the like, and is, for example, preferably within a range of 95/5 to 20/80, and more preferably within a range of 90/10 to 30/70. The primary dispersant and the secondary dispersant may both be added at once at the initial stage of the polymerization, or may be added in fractions during the polymerization.

### EXAMPLES

Hereinafter, the present invention is more specifically described by way of Examples, but the present invention is not limited by these Examples. It is to be noted that “parts”, “%”, and “ppm” have meanings on a mass basis, unless otherwise specified particularly.

### Viscosity-Average Degree of Polymerization of PVA

The viscosity-average degree of polymerization of the PVA was measured in accordance with JIS K6726: 1994. Specifically, in a case in which the degree of saponification of the PVA was less than 99.5 mol %, the viscosity-average degree of polymerization was determined in accordance with the following equation (11) using a limiting viscosity [η] (L/g) measured in water at 30° C. on the PVA, which had been obtained upon being saponified until the degree of saponification became 99.5 mol % or more:

viscosity-average degree of polymerization=([η]×10⁴/8.29)^{(1/0.62)} (11)

### Degree of Saponification of PVA

The degree of saponification of each PVA was determined by a method described in JIS K6726: 1994.

### Absorbance of Aqueous Solution of PVA

A 0.1% by mass aqueous solution of the PVA was prepared, and an absorbance (optical path length: 10 mm) at 320 nm was measured using “UV-2450”, an absorption photometer manufactured by Shimadzu Corporation.

### HSP Distance (Synthesis Examples 1 to 11, 17 to 19)

The HSP distance [R_{a,1}] ((J/cm³)^{1/2}) and the HSP distance [R_{a,2}] ((J/cm³)^{1/2}) were calculated in accordance with the following procedure.

First, the PVA was re-saponified until the degree of saponification became 99.5 mol % or more, and then washed with methanol. Using a 1% by mass D₂O solution of the PVA thus obtained (containing 0.1% by mass trimethylsilyl propanoic acid added as an internal standard) as a sample, a ¹H-NMR measurement was carried out (400 MHz, 80° C., cumulative times: 256). In a case in which a linear alkyl aldehyde was used as a modifying agent, a structure represented by the following formula (4) was formed as the structure represented by the formula (1). Moreover, m in the formula (4) was determined by the following equation (13) based on the result of the ¹H-NMR measurement.

—(C═O)—(CH₂)ₘ—CH₃ (4)

m={(peak (a) integrated value)×3}/(peak (b) integrated value)×2}+2 (13)

In the equation (13), peak (a) represents a peak derived from methylene of the alkyl chain present between 1.22 and 1.38 ppm; and peak (b) represents a peak derived from methyl of the alkyl chain present between 0.80 and 0.92 ppm. In a case in which peak (b) was not present and a peak was present in an area of 0.94 to 1.08 ppm, m was defined as 1, and in a case in which neither peak (a) nor peak (b) was present, m was defined as 0.

Based on a structure obtained from the ¹H-NMR spectrum, the HSP distance [R_{a,1}] and the HSP distance [R_{a,2}] were calculated using the equations (5) to (10).

### HSP Distance (Synthesis Examples 12, 13: Reference Values)

As described later, as the modifying agent, 1-hexene was used in Synthesis Example 12, and 1-decene was used in Synthesis Example 13. The PVAs obtained in these cases have an alkyl group in a side chain. The HSP distance [R_{b}] between the alkyl group and vinyl chloride or water was calculated as a reference value. Specifically, R_{b} was calculated in accordance with the following procedure.

A ¹H-NMR measurement was carried out by the same procedure as described above. In a case of using an α-olefin as the modifying agent, n in the structure represented by the following formula (14), derived from the modifying agent incorporated into the PVA, is determined in accordance with the following equation (15).

—(CH₂)ₙ—CH₃ (14)

n={(peak (c) integrated value/2)/{peak (d) integrated value}/3} (15)

In the equation (15), peak (c) represents a peak present between 1.1 and 1.3 ppm; and peak (d) represents a peak present between 0.80 and 0.92 ppm.

Next, the HSP distance was calculated. A molar volume of the structure represented by the formula (14) can be calculated in accordance with the following equation (16), and the HSP values can be calculated in accordance with the following equations (17) to (19).

V=33.5+n×16.1 (16)

δd=(420+n×270)/V (17)

δp=0 (18)

δh=0 (19)

Next, R_{b} was calculated using the following equation (20). The HSP values adopted for the vinyl chloride monomer were (δD, δP, δH)=(15.4, 8.1, 2.4), and the HSP values adopted for water were (δD, δP, δH)=(15.5, 16.0, 42.4).

[R_{b}]={4(δD−δd)²+(δP−δp)²+(δH−δh)²}^{1/2} (20)

### HSP Distance (Synthesis Examples 14, 15: Reference Values)

As described later, as the modifying agent, 1-octanethiol was used in Synthesis Example 14, and 1-hexanethiol was used in Synthesis Example 15. The PVAs obtained in these cases have an alkylthiol group at an end thereof. The HSP distance between the alkylthiol group and vinyl chloride or water was calculated as a reference value by a similar operation to the method described above, in accordance with the method described in “SP Values: Fundamentals, Application, and Calculation Method”, written by Hideki Yamamoto (published in 2005, Johokiko Co., Ltd.), and “Polymer Handbook (Fourth Edition)”, written by J. Brandrup (published in 2003, Wiley).

### Degree of Modification

A percentage content (mol %) of units modified by the modifying agent with respect to the total structural units of the PVA is referred to as the “degree of modification”. It is to be noted that when the unit modified by the modifying agent is the structure represented by the formula (1), the degree of modification has the same meaning as the percentage content [X] (mol %) of the structure represented by the formula (1) with respect to the total structural units in the vinyl alcohol polymer.

A ¹H-NMR measurement was carried out, and the degree of modification (mol %) was calculated. The PVA was re-saponified until the degree of saponification became 99.5 mol % or more, and then washed with methanol. Using a 1% by mass D₂O solution of the PVA thus obtained (containing 0.1% by mass trimethylsilyl propanoic acid added as an internal standard) as a sample, a ¹H-NMR measurement was carried out (400 MHz, 80° C., cumulative times: 256). The degree of modification (mol %) was determined in accordance with the following equation (21) using an integrated value [M] of peaks derived from methine groups on a main chain of the PVA, an integrated value [O] of peaks derived from methyl groups contained in a structure derived from the modifying agent, and the number q of methyl groups per molecule of the modifying agent. It is to be noted that the peaks derived from the methine groups on the main chain of the PVA are present at 3.8 to 4.0 ppm. Furthermore, in a case in which the modifying agent is, for example, a linear alkyl aldehyde having 4 or more carbon atoms, the peaks derived from the methyl groups contained in the structure derived from the modifying agent are present at 0.80 to 0.92 ppm.

degree of modification (mol %)={([O]/(3×q))/[M]}×100 (21)

### Synthesis Example 1: Production of PVA-1

Into a reaction vessel equipped with a stirrer, a reflux condenser, a nitrogen inlet tube, and an addition port for a polymerization initiator were charged 1,000 parts by mass of vinyl acetate and 21.5 parts by mass of 1-octanal, and replacement with nitrogen in the system was carried out for 30 min while bubbling nitrogen. Elevation of the temperature of the reaction vessel was started, and 1.1 parts by mass of 2,2′-azobisisobutyronitrile (AIBN) were added to initiate the polymerization when an internal temperature of 60° C. was attained. After conducting the polymerization at 60° C. for 3 hrs, cooling was performed to stop the polymerization. A solid content concentration at the time of stopping the polymerization was 51.2% by mass, and the conversion was 50%. Subsequently, unreacted monomer was eliminated while adding methanol at 30° C. under reduced pressure at intervals to give a methanol solution of a vinyl ester polymer (concentration: 34.5%). Next, to 174.6 parts by mass of a methanol solution of the vinyl ester polymer (60 parts by mass of the polymer in the solution) prepared by further adding methanol to this methanol solution were added 3.7 parts by mass of a 10% by mass methanol solution of sodium hydroxide, 20 parts by mass of methyl acetate, and 2.0 parts by mass of ion exchanged water, and saponification was conducted at 40° C. (a concentration of the polymer in the saponification solution: 30% by mass, a molar ratio of sodium hydroxide to the vinyl acetate unit in the polymer: 0.013, and a moisture percentage of the saponification solution: 1% by mass). Since gelatinous matter was produced about 12 min after the methanol solution of sodium hydroxide was added, the gelatinous matter was ground with a grinder. Thereafter, the mixture was left to stand at 40° C. for 1 hour to allow saponification to proceed. Subsequently, 160 parts by mass of methyl acetate and 40 parts by mass of methanol were added thereto and the mixture was left to stand at 40° C. for 30 min to permit washing. After this operation for washing was repeated twice, a white solid obtained by deliquoring was vacuum-dried at 40° C. for 16 hrs, whereby a PVA (PVA-1) was obtained. Physical properties of the PVA-1 are shown in Table 2.

The PVA-1 was sufficiently washed with methyl acetate using a Soxhlet extractor and was vacuum-dried at 40° C. for 16 hrs. Using a 1% by mass DMSO solution of the PVA-1 after the washing (containing 0.05% by volume tetramethylsilane added as an internal standard) as a sample, a ¹H-NMR measurement (400 MHz, 80° C., cumulative times: 256) was conducted. A percentage content of the formyl group with respect to total structural units in the PVA-1 was determined based on this result, and was 3.0 mmol % or less.

### Synthesis Examples 2 to 8, 10 to 13, 17, and 19: Production of PVA-2 to 8, 10 to 13, 17, and 19

PVAs (PVA-2 to 8, 10 to 13, 17, and 19) of Synthesis Examples 2 to 8, 10 to 13, 17, and 19 were each produced by procedures similar to that of Synthesis Example 1, except that changes were carried out such that polymerization conditions involving the amount of vinyl acetate and methanol charged and the type and the amount of addition of the modifying agent used in the polymerization; and saponification conditions involving the concentration of the vinyl ester polymer during the saponification and the molar ratio of the sodium hydroxide to the vinyl acetate unit were as shown in Table 1. It is to be noted that in the case of PVA-8, polyvinyl acetate-methanol solutions of each of PVA-8A and PVA-8B were mixed in a 6:4 ratio, and then saponification was conducted. The physical properties of PVA-2 to 8, 10 to 13, 17, and 19 are shown in Table 2.

### Production of Synthesis Example 14: PVA-14

Into a reaction vessel equipped with a stirrer, a reflux condenser, a nitrogen inlet tube, a chain transfer agent-dripping port, and an addition port for a polymerization initiator were charged 1,200 parts by mass of vinyl acetate and 0.18 parts by mass of 1-octanethiol, and replacement with nitrogen in the system was carried out for 30 min while bubbling nitrogen. Furthermore, replacement of nitrogen in the methanol solution of 1-octanethiol (concentration: 1.8% by mass) was carried out by bubbling nitrogen gas. Elevation of the temperature of the reaction vessel was started, and 0.75 parts by mass of 2,2′-azobisisobutyronitrile (AIBN) were added to initiate the polymerization when an internal temperature of 60° C. was attained. The methanol solution of 1-octanethiol was added dropwise into the reaction vessel, and while maintaining a monomer composition ratio in the polymerization solution to be constant, the polymerization was conducted at 60° C. for 2 hrs, followed by performing cooling to stop the polymerization. A solid content concentration at the time of stopping the polymerization was 39.4% by mass, and the conversion was 40%. Furthermore, 2.05 parts by mass of 1-octanethiol were added, including the amount charged at the beginning. Subsequently, unreacted monomer was eliminated while adding methanol at 30° C. under reduced pressure at intervals to give a methanol solution of a vinyl ester polymer (concentration: 38.2%). Next, to 175.8 parts by mass of a methanol solution of the vinyl ester polymer (60 parts by mass of the polymer in the solution) prepared by further adding methanol to this methanol solution were added 2.5 parts by mass of a 10% methanol solution of sodium hydroxide, 20 parts by mass of methyl acetate, and 2.0 parts by mass of ion exchanged water, and saponification was conducted at 40° C. (a concentration of the polymer in the saponification solution: 25% by mass, a molar ratio of sodium hydroxide to the vinyl acetate unit in the polymer: 0.0075, and a moisture percentage of the saponification solution: 1% by mass). Since gelatinous matter was produced about 10 min after the methanol solution of sodium hydroxide was added, the gelatinous matter was ground with a grinder. Thereafter, this mixture was left to stand at 40° C. for 1 hour to allow saponification to proceed. Subsequently, 160 parts by mass of methyl acetate and 40 parts by mass of methanol were added thereto and the mixture was left to stand at 40° C. for 30 min to permit washing. After this operation for washing was repeated twice, a white solid obtained by deliquoring was vacuum-dried at 40° C. for 16 hrs, whereby a PVA (PVA-14) was obtained. Physical properties of the PVA-14 are shown in Table 2.

### Production of Synthesis Example 15: PVA-15

A PVA (PVA-15) of Synthesis Example 15 was produced by a procedure similar to that of Synthesis Example 14, except that changes were carried out such that polymerization conditions involving the amount of vinyl acetate and methanol charged and the type and the amount of addition of the modifying agent used in the polymerization; and saponification conditions involving the concentration of the vinyl ester polymer during the saponification and the molar ratio of the sodium hydroxide to the vinyl acetate unit were as shown in Table 1. The physical properties of PVA-15 are shown in Table 2.

### Production of Synthesis Example 16: PVA-16

A PVA (PVA-16) of Synthesis Example 16 was produced by a procedure similar to that of Synthesis Example 1, except that changes were carried out such that polymerization conditions involving the amount of vinyl acetate and methanol charged and not using a modifying agent; and saponification conditions involving the concentration of the vinyl ester polymer during the saponification and the molar ratio of the sodium hydroxide to the vinyl acetate unit were as shown in Table 1. The physical properties of PVA-16 are shown in Table 2.

### Production of Synthesis Examples 9 and 18: PVA-9 and 18

In Synthesis Example 9, PVA-9 was synthesized by subjecting the PVA-1 to a heat treatment at 130° C. for 1 hour. In Synthesis Example 18, PVA-18 was synthesized by subjecting the PVA-17 to a heat treatment at 130° C. for 1 hour. The physical properties of PVA-9 and 18 are shown in Table 2.

TABLE 1

| | | Usage Amount | | | | | | Saponification Conditions | | |
|---|---|---|---|---|---|---|---|---|---|---|
| | | | | Modification agent | | | | Concentration | | |
| | | Vinyl | | | addition | | | of vinyl | | |
| | | acetate | Methanol | | amount | AIBN | Con- | acetate | Molar | Moisture |
| | | (parts | (parts | | (parts | (parts | version | polymer | ratio of | percentage |
| | | by mass) | by mass) | type | by mass) | by mass) | (%) | (%) | NaOH | (%) |
| Synthesis Example 1 | PVA-1 | 1,000 | 0 | 1-octanal | 21.5 | 1.1 | 50 | 30 | 0.013 | 1 |
| Synthesis Example 2 | PVA-2 | 1,200 | 0 | 1-hexanal | 20.0 | 0.7 | 50 | 30 | 0.013 | 1 |
| Synthesis Example 3 | PVA-3 | 1,200 | 0 | 1-decanal | 22.6 | 1.3 | 60 | 30 | 0.012 | 1 |
| Synthesis Example 4 | PVA-4 | 1,500 | 0 | 1-octanal | 45.5 | 2.2 | 65 | 30 | 0.011 | 1 |
| Synthesis Example 5 | PVA-5 | 1,200 | 0 | 1-octanal | 19.0 | 0.7 | 50 | 30 | 0.010 | 1 |
| Synthesis Example 6 | PVA-6 | 1,200 | 0 | 1-hexanal | 15.0 | 0.7 | 50 | 30 | 0.010 | 1 |
| Synthesis Example 7 | PVA-7 | 1,000 | 0 | 1-octanal | 21.5 | 1.1 | 50 | 30 | 0.019 | 1 |
| Synthesis Example 8 | PVA-8A | 1,600 | 0 | 1-octanal | 20.0 | 1.1 | 40 | 25 | | 1 |
| | PVA-8B | 1,600 | 0 | 1-octanal | 150.0 | 2.0 | 50 | | 0.010 | |
| Synthesis Example 9 | PVA-9 | 1,000 | 0 | 1-octanal | 21.5 | 1.1 | 50 | 30 | 0.013 | 1 |
| Synthesis Example 10 | PVA-10 | 1,280 | 320 | 1-undecanal | 79.0 | 0.5 | 40 | 30 | 0.018 | 1 |
| Synthesis Example 11 | PVA-11 | 1,600 | 0 | acetaldehyde | 28.0 | 0.9 | 45 | 30 | 0.0097 | 1 |
| Synthesis Example 12 | PVA-12 | 612 | 588 | 1-hexene | 2.5 | 1.5 | 70 | 25 | 0.0074 | 1 |
| Synthesis Example 13 | PVA-13 | 612 | 588 | 1-decene | 4.2 | 1.5 | 70 | 25 | 0.0071 | 1 |
| Synthesis Example 14 | PVA-14 | 1,200 | 0 | 1-octanethiol | 2.1 | 0.75 | 40 | 25 | 0.0075 | 1 |
| Synthesis Example 15 | PVA-15 | 1,200 | 0 | 1-hexanethiol | 2.0 | 0.75 | 40 | 25 | 0.0078 | 1 |
| Synthesis Example 16 | PVA-16 | 612 | 588 | — | 0 | 1.0 | 70 | 25 | 0.0071 | 1 |
| Synthesis Example 17 | PVA-17 | 1,040 | 560 | 1-octanal | 15.0 | 0.4 | 50 | 30 | 0.0076 | 1 |
| Synthesis Example 18 | PVA-18 | 1,040 | 560 | 1-octanal | 15.0 | 0.4 | 50 | 30 | 0.0076 | 1 |
| Synthesis Example 19 | PVA-19 | 1,000 | 0 | 1-butanal | 12.0 | 1.0 | 65 | 30 | 0.012 | 1 |

* PVA-9 and PVA-18 were subjected to a heat treatment.

TABLE 2

| | | Viscosity- | | Degree of | | | | Parameter A of | Parameter B of |
|---|---|---|---|---|---|---|---|---|---|
| | | average | Degree of | saponifi- | | HSP distance | | degree of | degree of |
| | | degree of | modification | cation | Absorbance | from vinyl | HSP distance | modification and | modification and |
| | | polymerization | (mol %) | (mol %) | at 320 nm | chloride | from water | HSP distance | HSP distance |
| Synthesis | PVA-1 | 735 | 0.21 | 71.4 | 0.14 | 3.5 | 39.8 | 1.76 | 13.27 |
| Example 1 | | | | | | | | | |
| Synthesis | PVA-2 | 705 | 0.20 | 71.8 | 0.21 | 3.0 | 39.1 | 2.16 | 13.06 |
| Example 2 | | | | | | | | | |
| Synthesis | PVA-3 | 872 | 0.18 | 70.4 | 0.17 | 4.2 | 40.5 | 1.02 | 10.97 |
| Example 3 | | | | | | | | | |
| Synthesis | PVA-4 | 550 | 0.24 | 72.6 | 0.11 | 3.4 | 39.7 | 2.13 | 15.26 |
| Example 4 | | | | | | | | | |
| Synthesis | PVA-5 | 960 | 0.13 | 70.8 | 0.10 | 3.5 | 39.9 | 1.04 | 8.18 |
| Example 5 | | | | | | | | | |
| Synthesis | PVA-6 | 899 | 0.15 | 70.0 | 0.13 | 3.1 | 39.2 | 1.61 | 9.78 |
| Example 6 | | | | | | | | | |
| Synthesis | PVA-7 | 735 | 0.26 | 75.3 | 0.14 | 3.4 | 39.7 | 2.31 | 16.53 |
| Example 7 | | | | | | | | | |
| Synthesis | PVA-8 | 750 | 0.20 | 71.7 | 0.09 | 3.3 | 39.6 | 1.80 | 12.73 |
| Example 8 | | | | | | | | | |
| Synthesis | PVA-9 | 735 | 0.21 | 71.4 | 0.32 | 3.5 | 39.8 | 1.76 | 13.27 |
| Example 9 | | | | | | | | | |
| Synthesis | PVA-10 | 900 | 0.12 | 80.0 | 0.09 | 4.8 | 41.0 | 0.52 | 7.14 |
| Example 10 | | | | | | | | | |
| Synthesis | PVA-11 | 760 | 0.11 | 73.0 | 0.07 | 10.3 | 35.7 | 0.10 | 8.62 |
| Example 11 | | | | | | | | | |
| Synthesis | PVA-12 | 805 | 0.21 | 70.0 | 0.01 | 8.5 | 45.3 | 0.29 | 10.22 |
| Example 12 | | | | | | | | | |
| Synthesis | PVA-13 | 759 | 0.20 | 70.5 | 0.01 | 8.5 | 45.3 | 0.28 | 9.74 |
| Example 13 | | | | | | | | | |
| Synthesis | PVA-14 | 892 | 0.17 | 70.9 | 0.02 | 9.3 | 45.5 | 0.20 | 8.22 |
| Example 14 | | | | | | | | | |
| Synthesis | PVA-15 | 743 | 0.21 | 72.2 | 0.02 | 12.3 | 46.2 | 0.14 | 9.85 |
| Example 15 | | | | | | | | | |
| Synthesis | PVA-16 | 750 | 0.00 | 72.5 | 0.01 | — | — | — | — |
| Example 16 | | | | | | | | | |
| Synthesis | PVA-17 | 1,000 | 0.038 | 72.0 | 0.05 | 3.6 | 39.7 | 0.29 | 2.41 |
| Example 17 | | | | | | | | | |
| Synthesis | PVA-18 | 1,000 | 0.038 | 72.0 | 0.16 | 3.6 | 39.7 | 0.29 | 2.41 |
| Example 18 | | | | | | | | | |
| Synthesis | PVA-19 | 605 | 0.150 | 71.1 | 0.11 | 3.8 | 37.7 | 1.02 | 10.56 |
| Example 19 | | | | | | | | | |

Parameter A of degree of modification and HSP distance = (degree of modification) × 10²/(HSP distance from vinyl chloride)²
Parameter B of degree of modification and HSP distance = (degree of modification) × 10⁵/(HSP distance from water)²

### Example 1

Suspension polymerization of vinyl chloride was carried out by the following method by using the PVA-1 obtained as a dispersant for suspension polymerization. Next, particles of the vinyl chloride polymer obtained were evaluated on the average particle diameter, the amount of coarse particles, and the plasticizer absorptivity. The evaluation results are shown in Table 3.

Suspension Polymerization of Vinyl Chloride

The vinyl alcohol polymer obtained as described above was dissolved in deionized water so as to reach an amount equivalent to 1,000 ppm with respect to the vinyl chloride to prepare an aqueous dispersant liquid. 1,150 g of the aqueous dispersant solution thus obtained was charged into an autoclave having a volume of 5 L. Subsequently, 0.65 g of a 70% toluene solution of cumyl peroxyneodecanoate, and 1.05 parts by mass of a 70% toluene solution of t-butyl peroxyneodecanoate were charged thereinto. Degassing was performed to remove oxygen such that pressure inside the autoclave was 0.0067 MPa. Thereafter, 800 g of vinyl chloride was charged thereinto, and a temperature of the contents inside the autoclave was raised to 57° C. to start polymerization under stirring. The pressure inside the autoclave at the time of starting the polymerization was 0.83 MPa. The polymerization was terminated at a point of time 3.5 hrs after the start of the polymerization when the pressure inside the autoclave had reached 0.70 MPa, and unreacted vinyl chloride was removed. Subsequently, a polymerization slurry was taken out and drying was performed at 65° C. for 17 hrs to give vinyl chloride polymer particles.

Evaluation of Vinyl Chloride Polymer Particles

### (1) Average Particle Diameter of Vinyl Chloride Polymer Particles

A particle diameter distribution was measured by a dry sieve analysis using a wire mesh with a Tyler mesh standard. Results thereof were plotted in accordance with the Rosin-Rammler distribution equation, and an average particle diameter (dₚ₅₀; median diameter) was calculated.

### (2) Amount of Coarse Particles

A content of the vinyl chloride polymer particles obtained, which did not pass through a sieve having a mesh opening size of 250 m (60 mesh in terms of mesh of JIS-standard sieve) was expressed in terms of % by mass. The value being lower indicates fewer coarse particles, suggesting a sharp particle diameter distribution and superiority in polymerization stability.

### (3) Plasticizer Absorptivity (CPA)

A mass of a syringe having a volume of 5 mL, packed with 0.02 g of absorbent cotton, was weighed (defined as A (g)), and then a mass after charging thereinto 0.5 g of the vinyl chloride polymer particles was weighed (defined as B (g)). Thereinto was charged 1 g of dioctyl phthalate (DOP), and the syringe was left to stand for 15 min. Subsequently, centrifugal separation was performed under conditions involving 3,000 rpm and 40 min, and a mass was weighed (defined as C (g)). Then, the plasticizer absorptivity (%) was determined in accordance with the following equation (22). The plasticizer absorptivity being higher indicates that processing is easier, suggesting mainly that defects generated in the appearance, such as aggregates, are unlikely to appear during processing into a sheet. It is to be noted that in a case in which the polymerization is unstable and the average particle diameter is high and there are many coarse particles, the plasticizer absorptivity becomes higher, but this is not due to the porosity of the polymer particles. In this evaluation, the plasticizer absorptivity was assessed as being favorable when the plasticizer absorptivity in a case of the average particle diameter being smaller than 180 μm was 27% or more, and as being more favorable when the plasticizer absorptivity was 29% or more.

plasticizer absorptivity (%)=100×[{(C−A)/(B−A)}−1] (22)

### Examples 2 to 10 and Comparative Examples 1 to 9

The suspension polymerization of the vinyl chloride was conducted by a similar procedure to that of Example 1, except that a type of the PVA used as the dispersant for suspension polymerization was changed as shown in Table 3. The results are shown in Table 3.

TABLE 3

| | | Average | Coarse particle | Plasticizer |
|---|---|---|---|---|
| | | particle | amount (% by | absorptivity |
| | | diameter (μm) | mass) | (%) |
| Example 1 | PVA-1 | 147 | 4.5 | 32 |
| Example 2 | PVA-2 | 133 | 2.3 | 32 |
| Example 3 | PVA-3 | 131 | 2.8 | 30 |
| Example 4 | PVA-4 | 150 | 3.3 | 32 |
| Example 5 | PVA-5 | 139 | 3.8 | 31 |
| Example 6 | PVA-6 | 155 | 4.6 | 30 |
| Example 7 | PVA-7 | 139 | 3.1 | 34 |
| Example 8 | PVA-8 | 143 | 4.0 | 29 |
| Example 9 | PVA-9 | 127 | 0.1 | 27 |
| Example 10 | PVA-10 | 163 | 4.9 | 29 |
| Comparative | PVA-11 | 187 | 15.2 | 29 |
| Example 1 | | | | |
| Comparative | PVA-12 | 238 | 60.0 | 30 |
| Example 2 | | | | |
| Comparative | PVA-13 | 224 | 58.3 | 28 |
| Example 3 | | | | |
| Comparative | PVA-14 | 182 | 22.6 | 28 |
| Example 4 | | | | |
| Comparative | PVA-15 | 196 | 39.5 | 27 |
| Example 5 | | | | |
| Comparative | PVA-16 | measurement failed due to blocking | | |
| Example 6 | | | | |
| Comparative | PVA-17 | 179 | 18.7 | 28 |
| Example 7 | | | | |
| Comparative | PVA-18 | 171 | 16.9 | 25 |
| Example 8 | | | | |
| Comparative | PVA-19 | 175 | 19.9 | 27 |
| Example 9 | | | | |

In the case of using the dispersants for suspension polymerization (PVA-1 to 10) of Examples 1 to 10, all of the vinyl chloride particles obtained had a small average particle diameter with few coarse particles, and favorable polymerization stability. Furthermore, the vinyl chloride particles all had favorable plasticizer absorptivity.

It is to be noted that of the Examples, the plasticizer absorptivity of Example 9, in which the heat-treated PVA-9 was used, was not particularly high, but the plasticizer absorptivity can be improved by decreasing the usage amount of the dispersant. Since the polymerization stability of the PVA-9 is extremely high, the average particle diameter can be maintained to be sufficiently low even if the usage amount of the dispersant is decreased. Furthermore, when comparing Example 1 and Example 9, which differ only with regard to whether the PVA was subjected to a heat treatment, it was revealed that in Example 9, in which the heat-treated PVA-9 was used, the polymerization stability was significantly improved. On the other hand, when comparing Comparative Example 7 and Comparative Example 8, which similarly differ only with regard to whether the PVA was subjected to a heat treatment, the improvement effect due to the heat treatment was small. This suggests that when the PVA having the structure represented by the formula (1) and satisfying the inequality (2) is subjected to a heat treatment, the polymerization stability is significantly improved.

Furthermore, of the Examples, Example 10 involved using the PVA-10, in which each of [X]×10²/[R_{a,1}]² (the parameter A of the degree of modification and the HSP distance) and [X]×10⁵/[R_{a,2}]²(the parameter B of the degree of modification and the HSP distance) was comparatively low, and exhibited a result in which the polymerization stability was somewhat low. This reveals that when a PVA in which these parameters are appropriately adjusted is used, the polymerization stability can be further enhanced.

On the other hand, in Comparative Examples 1 to 5 and 7 to 9, the average particle diameter of the vinyl chloride polymer particles obtained was large. This is speculated to be because in the PVA-11 to the PVA-15, the PVA-17, and the PVA-18 which were used, the value of the parameter A of the degree of modification and the HSP distance was less than 0.4, whereby miscibility between modified sites of the PVA and the vinyl chloride monomer was low, resulting in the amount of the PVA present at the interface between the vinyl chloride monomer and water being low. Furthermore, it is speculated that since in the PVA-19, R in the formula (1) had 3 carbon atoms and hydrophobicity was low, miscibility between modified sites of the PVA and the vinyl chloride monomer was low, resulting in the amount of the PVA present at the interface between the vinyl chloride monomer and water being low. Moreover, in Comparative Example 6, in which the unmodified PVA-16 was used as the dispersant, vinyl chloride underwent blocking and the polymerization could not be carried out; thus, the vinyl chloride polymer particles could not be obtained.

### INDUSTRIAL APPLICABILITY

The dispersant for suspension polymerization of the present invention can be used as, e.g., a dispersant in suspension polymerization of a vinyl compound.

1. A dispersant suitable for suspension polymerization, the dispersant comprising:
a vinyl alcohol polymer comprising a structure of formula (1): 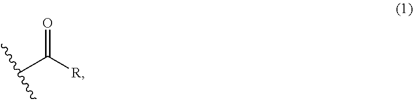
and satisfying inequality (2):
0.4≤[X]×10²/[R_{a,1}]²≤3.0 (2),
wherein, in formula (1), R is a hydrocarbon group having 4 or more carbon atoms, and
wherein, in inequality (2)
[X] is a mole percentage content of the structure of formula (1) with respect to total structural units of the vinyl alcohol polymer, and
[R_{a,1}] is an HSP distance in ((J/cm³)^{1/2}) between the structure of formula (1) and vinyl chloride.

2. The dispersant of claim 1, wherein the vinyl alcohol polymer has a degree of saponification in a range of from 60 to 99.5 mol %.

3. The dispersant of claim 1, wherein the vinyl alcohol polymer has a viscosity-average degree of polymerization in a range of from 150 to 5,000.

4. The dispersant of claim 1, wherein the vinyl alcohol polymer further satisfies inequality (3):
3.5≤[X]×10⁵/[R_{a,2}]²≤25 (3):
wherein, in inequality (3),
[X] is the same as in inequality (2), and
[R_{a,2}] is an HSP distance in ((J/cm³)^{1/2}) between the structure of formula (1) and water.

5. A method for producing a vinyl polymer, the method comprising:
subjecting a vinyl compound to suspension polymerization in the presence of the dispersant of claim 1.

6. The dispersant of claim 2, wherein the vinyl alcohol polymer has a viscosity-average degree of polymerization in a range of from 150 to 5,000.

7. The dispersant of claim 2, wherein the vinyl alcohol polymer further satisfies inequality (3):
3.5≤[X]×10⁵/[R_{a,2}]²≤25 (3),
wherein, in inequality (3),
[X] is the same as in inequality (2), and
[R_{a,2}] is an HSP distance in ((J/cm³)^{1/2}) between the structure of formula (1) and water.

8. The dispersant of claim 3, wherein the vinyl alcohol polymer further satisfies inequality (3):
3.5≤[X]×10⁵/[R_{a,2}]²≤25 (3),
wherein, in inequality (3),
[X] is the same as in inequality (2), and
[R_{a,2}] is an HSP distance in ((J/cm³)^{1/2}) between the structure of formula (1) and water.

9. The dispersant of claim 6, wherein the vinyl alcohol polymer further satisfies inequality (3):
3.5≤[X]×10⁵/[R_{a,2}]²≤25 (3),
wherein, in inequality (3),
[X] is the same as in inequality (2), and
[R_{a,2}] is an HSP distance in ((J/cm³)^{1/2}) between the structure of formula (1) and water.
